(19) United States
(12) Patent Application Publication
(10) Pub. No.: US 2025/0198914 A1
(43) Pub. Date: Jun. 19, 2025

(54) ATOMIC ABSORPTION SPECTROPHOTOMETER

(71) Applicant: SHIMADZU CORPORATION, Kyoto (JP)

(72) Inventor: Shihomi UZAWA, Kyoto-shi (JP)

(73) Assignee: SHIMADZU CORPORATION, Kyoto (JP)

(21) Appl. No.: 18/845,881

(22) PCT Filed: Dec. 7, 2022
(86) PCT No.: PCT/JP2022/045186

§ 371 Date: Jan. 17, 2025

(30) Foreign Application Priority Data
Mar. 29, 2022 (JP) 2022-053937

(51) Int. Cl. G01N 21/31; G01J 3/42; G01N 21/74

(52) U.S. Cl. CPC G01N 21/3103; G01J 3/42; G01N 21/74

(57) ABSTRACT

An atomic absorption spectrophotometer (1), including: a sample collection unit (24) to which a chip (25) configured to collect and eject a sample is attached; a sample heating unit (11) configured to excite the sample, provided with an opening (14) in an upper face into which the sample is injected from the sample collection unit (24); a moving mechanism (27) configured to move the sample collection unit between a first position for collecting the sample into the chip and a second position for injecting the sample from the chip to the opening; a light irradiating unit (29) configured to irradiate a light on the opening from a predetermined lighting direction; and an image acquisition unit (26) configured to image the opening from an optical axis direction different from the lighting direction.

### TECHNICAL FIELD

The present invention relates to an atomic absorption spectrophotometer.

### BACKGROUND ART

An atomic absorption spectrophotometer is used to quantify elements such as metals contained in a liquid sample such as drinking water (for example, Patent Literature 1). In the atomic absorption spectrophotometer, a liquid sample is thermally decomposed to generate atomic vapor, and the atomic vapor is irradiated with a light to measure the absorbance.

The atomic absorption spectrophotometer includes a measurement unit and an autosampler. The measurement unit includes a sample heating unit, a light source that irradiates atomic vapor with a light, the atomic vapor having been generated by the sample heating unit, and a detector that detects a light having passed through the atomic vapor. The sample heating unit is provided with a sample injecting portion provided for injecting a liquid sample. The autosampler includes a sample placement portion on which a plurality of sample containers containing liquid samples are set, an arm a tip to which a chip having a tubular shape used to collect the liquid samples from the sample containers is attached, and a moving mechanism that moves the arm between a sample collecting position and a sample injecting position. When analysis is performed, the chip attached to the arm of the autosampler is inserted into a sample container to collect the liquid sample, and the arm is moved such that the tip is inserted into the sample injecting portion to inject the liquid sample into the sample heating unit. In many cases, a graphite furnace is used as the sample heating unit, in which an opening serving as the sample injecting portion is provided in its upper face.

Through the repeated use of such an autosampler, the chip deteriorates, so that an error occurs in sample injection amount; and clogging of the chip occurs, whereby the liquid sample previously measured remains in the chip, so that contamination occurs. In order to prevent these problems, the analyst needs to replace the chip at an appropriate time. In addition, since the sample heating unit also deteriorates through the repeated use, the analyst replaces the sample heating unit at an appropriate time. At this time, since the analyst manually replaces the chip and/or the sample heating unit, a mount error, for example, attachment of the chip in a tilted state to the arm or deviation of the attachment position of the sample heating unit, may occur. In the atomic absorption spectrophotometer, for example, the size of the opening of the sample injecting portion is 1.8 mm in diameter and the outer diameter of the chip is 1.5 mm, and the error in the radial direction allowed on either side of the chip is very small, less than 0.15 mm. If the mount error exceeds this error, the chip comes into contact with the sample injecting portion. Therefore, conventionally, after the chip is replaced, it is necessary to perform an operation called teaching in which the movement control of the arm is adjusted so that the tip of the chip is located immediately above the sample injecting portion. Patent Literature 2 and Patent Literature 3 describe that an image acquired by a camera disposed at a position where both the tip of the chip and the sample injecting portion are simultaneously captured is displayed on a monitor, and teaching is performed with an analyst monitoring that image.

### CITATION LIST

### Patent Literature

Patent Literature 1: JP 3127657 U

Patent Literature 2: WO 2021/124513 A

Patent Literature 3: JP 2012-032310 A

### SUMMARY OF INVENTION

### Technical Problem

When teaching is performed, the sample injecting portion is imaged by the camera, and the chip is brought to a correct position with respect to the opening of the sample injecting portion while the imaged image is monitored. However, in the atomic absorption spectrophotometer, in order to prevent heat from escaping from the sample heating unit, portions other than the vicinity of the sample injecting portion are covered with a heat-insulating member. In addition, the light source and the detector disposed across the sample heating unit are also covered with a light-shielding member. Furthermore, as described above, the sample heating unit is a graphite furnace with a black surface. Therefore, even when an image obtained by imaging the surface of the graphite furnace in a dark place covered with the heat-insulating member and the light-shielding member is viewed, it is difficult to clearly grasp the position of the opening provided on the surface, and there is a problem that it is difficult to align the chip at a correct position with respect to the opening.

A problem to be solved by the present invention is to provide a technique capable of easily aligning a chip at a correct position with respect to an opening of a sample injecting portion provided in a sample heating unit of an atomic absorption spectrophotometer.

### Solution to Problem

An atomic absorption spectrophotometer according to the present invention made to solve the above problems includes:
a sample collection unit to which a chip configured to collect and eject a sample is attached;
a sample heating unit with an opening in an upper face, the opening being for injecting the sample into the sample heating unit;
a moving mechanism configured to move the sample collection unit between a first position for collecting the sample into the chip and a second position for injecting the sample from the chip to the opening;
a light irradiating unit configured to irradiate a light on the opening in a predetermined lighting direction; and
an image acquisition unit configured to image the opening from a direction along an optical axis different from a central axis of the light irradiated by the light irradiating unit.

### Advantageous Effects of Invention

In the atomic absorption spectrophotometer according to the present invention, while the opening provided in the upper face of the sample heating unit is irradiated with a light in a predetermined lighting direction by the light irradiating unit, the opening is imaged by the image acquisition unit from a direction along an optical axis different from an optical axis of the light irradiating unit. In the atomic absorption spectrophotometer according to the present invention, the light irradiation unit and the image acquisition unit having optical axes of different directions are used to acquire the image of the opening of the sample heating unit, so that the position of the opening can be easily identified to align the chip to the correct position.

### BRIEF DESCRIPTION OF DRAWINGS

FIG. 1 A schematic configuration diagram of an embodiment of an atomic absorption spectrophotometer according to the present invention.

FIG. 2 A diagram illustrating a positional relationship among an opening, a camera, an LED, and other components in the atomic absorption spectrophotometer of the present embodiment.

FIG. 3 A diagram illustrating a relationship between a region irradiated with a light from the LED and the field of view of the camera in the present embodiment.

FIG. 4 A flowchart of a procedure for determining the center position of the opening and the tip position of the chip in the present embodiment.

FIG. 5 An example of extracting a region including the tip of the chip in the present embodiment.

FIG. 6 An example of the obtained outline of the partial image of the tip of the chip in the present embodiment.

FIG. 7 An example of obtaining the intersection of the outline of the chip and the center line of the chip in the present embodiment.

FIG. 8 An example of a result of determining the tip position of the chip in the present embodiment.

FIG. 9 An example of the edges extracted from a partial image of a region including the opening in the present embodiment.

FIG. 10 A diagram illustrating the Hough transform.

FIG. 11 An example of the extracted region of the opening in the present embodiment.

FIG. 12 An example of a result of determining the center position of the opening in the present embodiment.

FIG. 13 A modification for identifying the tip position of the chip.

### DESCRIPTION OF EMBODIMENTS

An embodiment of an atomic absorption spectrophotometer according to the present invention will be described below with reference to the drawings. In the drawings used in the following description, illustration is made in a scale different from the actual scale or illustration of some components is omitted in order to clearly illustrate the configuration of main parts.

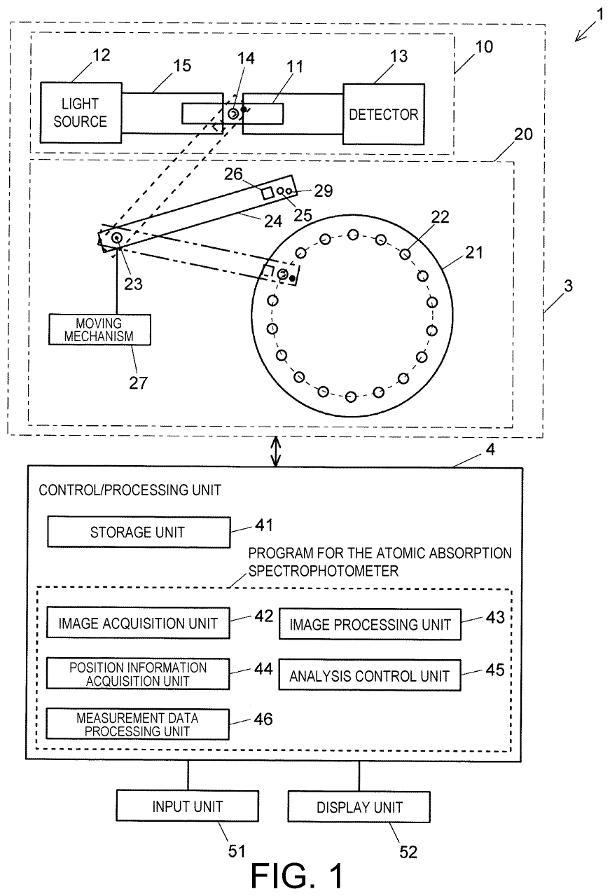

FIG. 1 is a schematic configuration diagram of an atomic absorption spectrophotometer 1 of the present embodiment. The atomic absorption spectrophotometer 1 roughly includes an analysis unit 3 including a measurement unit 10 and an autosampler 20, and a control/processing unit 4.

The measurement unit 10 includes: a sample heating unit 11, a light source 12 that irradiates atomic vapor with a light, the atomic vapor having been generated by the sample heating unit 11, and a detector 13 that detects a light having passed through the atomic vapor. The sample heating unit 11 is an electric heating furnace with a cylindrical shape having left and right openings and is provided with an opening 14 as a sample injecting portion at the center of the upper face of the sample heating unit 11. The size of the sample heating unit 11 in the present embodiment is, for example, 5 mm in diameter and 2 cm in length, and the diameter of the opening 14 is, for example, 1.8 mm. In the optical path from the light source 12 to the detector 13, a portion other than the vicinity of the opening 14 of the sample heating unit 11 is covered with a light-shielding/heat-insulating member 15 for shielding a light and insulating heat.

The autosampler 20 includes a turntable 21 on which a plurality of sample containers 22 containing liquid samples are set, an arm 24 with a tip portion having a lower face to which a chip 25 configured to collect the liquid samples from the sample containers 22 is attached, and a shaft member 23 to which a base end portion of the arm 24 is rotatably attached. The autosampler 20 is provided with a moving mechanism 27 configured to rotate and move the shaft member 23 in a horizontal plane and a vertical direction.

The moving mechanism 27 is configured to be capable of moving the arm 24 to which the chip 25 is attached to a first position (a position indicated with a two-dot chain line in FIG. 1) at which the liquid sample is collected, a second position (a position indicated with a broken line in FIG. 1) at which the liquid sample is injected into the opening 14 of the sample heating unit 11, and a third position (a position indicated with a solid line in FIG. 1) different from the first position and the second position. As the third position, a place where the contrast with respect to the background is large when the chip 25 is imaged is selected. The arm 24 is moved to the first position and the chip 25 is moved vertically downward to collect the sample in the sample container 22, and the arm 24 is moved to the second position and the chip 25 is moved vertically downward to inject the sample into the opening 14. The outer diameter of the chip 25 used in the present embodiment is, for example, 1.5 mm. The chip 25 in the present embodiment is tubular (hollow rod), but may have other shapes. Furthermore, for the second position, the arm 24 can also be moved to a position offset by a predetermined length in a predetermined direction from the position at the time of sample collection. Hereinafter, a position at which the chip 25 is disposed immediately above the opening 14 of the sample heating unit 11 to inject a sample is referred to as sample injecting position, and a position at which the chip 25 is shifted (offset) by a predetermined distance in the horizontal direction and/or the height direction from immediately above the opening 14 is also referred to as offset position. The offset position is used when the opening 14 of the sample heating unit 11 is imaged with the chip 25 being attached to the arm 24. The details of this imaging will be described later. Moving the arm 24 to the third position is not essential to the present invention, and setting the third position may be omitted in a case where the tip position of the chip 25 is identified by imaging the chip 25 at the offset position.

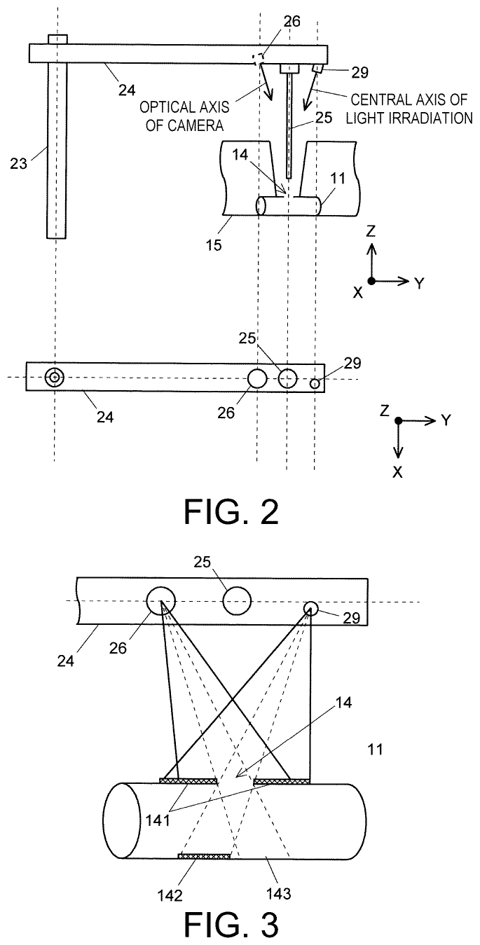

As illustrated in FIG. 2, a camera 26 is attached to the lower face of the arm 24 in a side closer to the base portion of the arm 24 than the chip 25 is. An LED 29 (not illustrated in FIG. 1) is attached to the lower face of the arm 24 in a side closer to the tip of the arm 24 than the chip 25 is. The LED 29 is disposed such that the center of the LED 29 is located off a straight line connecting the center of the detection surface of the camera 26 and the center of the base portion of the chip 25. When the arm 24 is at the second position, the LED 29 irradiates a region including the opening 14 of the sample heating unit 11 with a light. The camera 26 is attached in a direction in which both a region including the opening 14 of the sample heating unit 11 illuminated by the LED 29 and the tip of the chip 25 are captured in the field of view of the camera 26 when the arm 24 is at the second position.

FIG. 3 illustrates the region irradiated with a light from the LED 29 and the field of view of the camera 26 capturing the region when the arm 24 is at the second position. The light irradiated from the LED 29 illuminates a region 141 outside the opening 14 in the upper face of the sample heating unit 11, and enters through the opening 14 to illuminate a partial region 142 inside the sample heating unit 11. The camera 26 captures both the region 141, which is illuminated, outside the opening 14 in the upper face of the sample heating unit 11, and a partial region 143 inside the opening 14, in the field of view. The region 142 inside the sample heating unit 11 illuminated by the LED 29 is different from the region 143 inside the sample heating unit 11 captured by the camera 26. Therefore, in the image captured by the camera 26, the region 141 outside the opening 14 in the upper face of the sample heating unit 11 is bright, and the region 143 inside the opening 14 is dark.

The control/processing unit 4 includes a storage unit 41. The storage unit 41 stores various measurement conditions (for example, information in which a measurement target element, a type of a light source used at the time of measurement of the element, and a wavelength of light to be detected by the detector 13 are associated with each other, or other items) used at the time of measurement using the atomic absorption spectrophotometer 1. The storage unit 41 stores position information of the first position, the second position (including the offset position), and the third position (for example, coordinate information of the second position and the third position in the coordinate system with the first position as the origin), and information on the amount of movement of the arm 24 made by the moving mechanism 27 when the arm 24 is moved between the first position, the second position, and the third position. Besides that, the storage unit 41 stores various image processing programs used when the center position of the opening 14 of the sample heating unit 11 is determined, filters used for image processing, parameters used for image processing, and other items.

The control/processing unit 4 includes, as functional blocks, an image acquisition unit 42, an image processing unit 43, a position information acquisition unit 44, an analysis control unit 45, and a measurement data processing unit 46. An entity of the control/processing unit 4 is a general personal computer, and the above functional blocks are embodied by a processor executing a preinstalled program for the atomic absorption spectrophotometer. To the control/processing unit 4, an input unit 51 including a keyboard, a mouse, and the like and a display unit 52 including a liquid crystal display or the like.

The analysis control unit 45 reads out the measurement conditions stored in the storage unit 41 in response to an input operation by an analyst, and controls the operation of each unit constituting the analysis unit 3, thereby performing sample measurement. The measurement data processing unit 46 applies appropriate processing to the measurement data of the sample acquired by the analysis control unit 45, thereby analyzing the measurement data. The analysis control unit 45 and the measurement data processing unit 46 are similar to those included in a conventional atomic absorption spectrophotometer, and thus their detailed description will be omitted. Through the repeated use of the atomic absorption spectrophotometer 1, the chip 25

deteriorates, so that an error occurs in sample injection amount; and clogging of the chip 25 occurs, whereby the liquid sample previously measured remains in the chip 25, so that contamination occurs. In order to prevent these problems, the analyst needs to replace the chip 25 at an appropriate time. In addition, since the sample heating unit 11 also deteriorates through the repeated use, the analyst replaces the sample heating unit 11 at an appropriate time. At this time, since the analyst manually replaces the chip 25 and/or the sample heating unit 11, a mount error, for example, attachment of the chip 25 in a tilted state to the arm 24 or deviation of the attachment position of the sample heating unit 11, may occur. In the atomic absorption spectrophotometer 1 of the present embodiment, the size of the opening 14 of the sample heating unit 11 is 1.8 mm in diameter and the outer diameter of the chip 25 is 1.5 mm, and the error allowed in the radial direction is very small, 0.15 mm. If the deviation between the center position of the chip 25 and the center position of the opening 14 of the sample heating unit 11 exceeds this error, the chip 25 comes into contact with the sample injecting portion.

Conventionally, when a chip or a sample heating unit is replaced, both the chip and the opening of the sample heating unit are imaged by a camera, and the tip of the chip is aligned with the opening of the sample heating unit. However, the sample heating unit is at a deep position in the bottom portion of the light-shielding/heat-insulating member, and thus it is difficult to identify the opening of the sample heating unit.

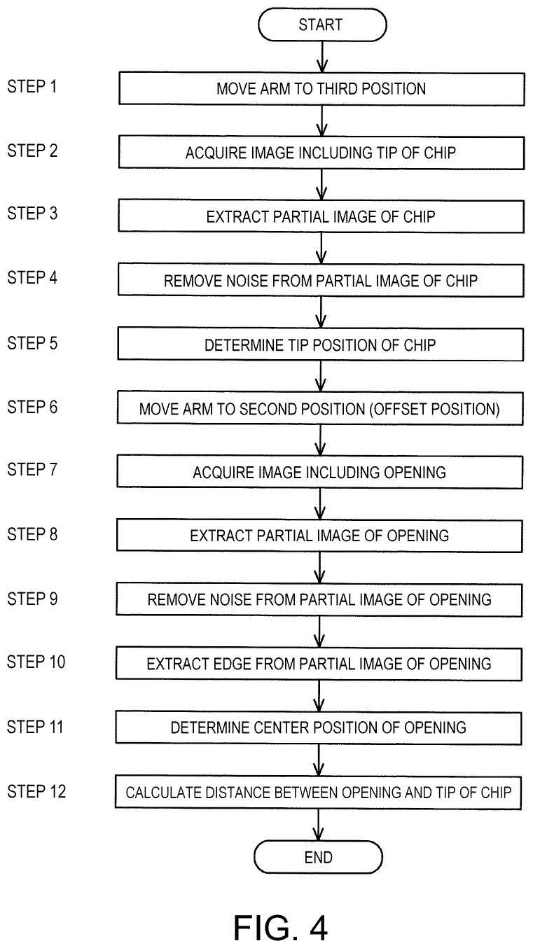

In the atomic absorption spectrophotometer 1 of the present embodiment, after replacing the sample heating unit 11 and/or the chip 25, the analyst identifies the center position of the opening 14 of the sample heating unit 11 and/or the tip position of the chip 25 by the following procedure. FIG. 4 is a flowchart of a procedure for identifying the positions of the center of the opening 14 of the sample heating unit 11 and the tip of the chip 25 in the present embodiment.

When the analyst performs a predetermined input operation to instruct for identifying the positions of the center of the opening 14 of the sample heating unit 11 and the tip of the chip 25, the image acquisition unit 42 moves the arm 24 to the third position with the moving mechanism 27 (step 1). The third position is the position indicated with a solid line in FIG. 1, and when the tip of the chip 25 is imaged at this position, an image in which only the tip of the chip 25 is captured without overlapping the opening 14 can be acquired.

Subsequently, while illuminating the vicinity of the tip of the chip 25 by turning on the LED 29, the image acquisition unit 42 acquires the image of the region including the tip of the chip 25 by the camera 26 (step 2) and stores the acquired image in the storage unit 41.

When the image including the tip of the chip 25 is acquired by the image acquisition unit 42, the image processing unit 43 first reads the image data from the storage unit 41, extracts the image of the tip portion of the chip 25 (partial image of the chip 25) (step 3), and displays the extracted image on the screen of the display unit 52. The processing of extracting the partial image of the chip 25 can be performed, for example, by automatically extracting an image within a predetermined area around the center of the image including the tip of the chip 25. Since the mount error that may occur when the chip 25 is attached is about several mm at the maximum, the size of the image to be extracted (the above predetermined area) may be set in advance so as to include the tip of the chip 25 even in a case where the maximum error occurs. Alternatively, the partial image including the tip of the chip 25 can be extracted on the basis of an attribution according to the shape or the area of the tip of the chip 25, such as the area, the center of gravity, the length of outer circumference, the circularity, and other characteristics of the cluster of bright parts or dark parts (in a case where the chip 25 is imaged brightly, that are bright parts) included in a binarized image obtained by binarizing the luminance values of the pixels constitute an entire image into bright and dark by using a predetermined threshold or a threshold determined from the luminance distribution in the image by statistical processing.

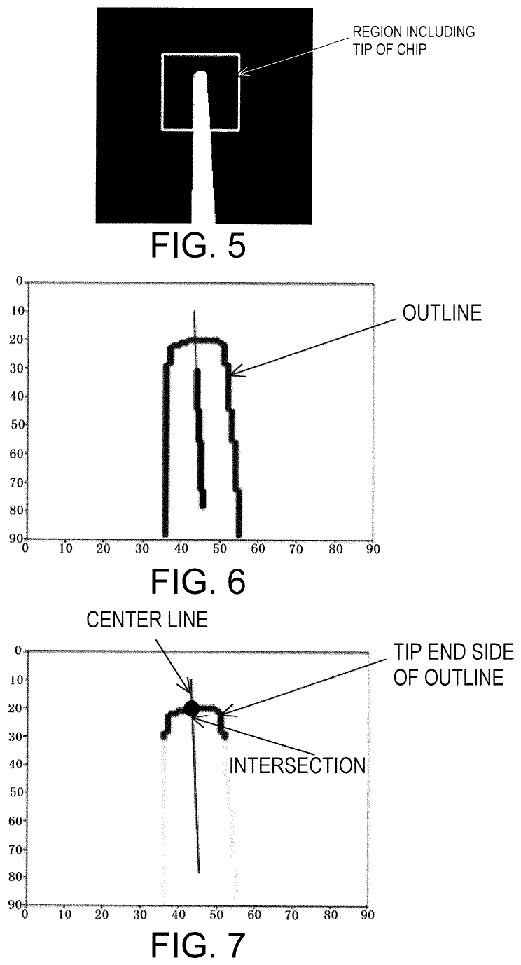

As illustrated in FIG. 5, a frame indicating the area of the partial image to be extracted by the above processing may be superimposed on the image read from the storage unit 41 to be displayed on the screen of the display unit 52 to allow the analyst to change the area of the partial image to be extracted as necessary. Step 3 may be omitted in a case where the tip of the chip 25 is captured sufficiently large in the image imaged by the camera 26 and there are few extra regions, or in a case where there is no region having similar shape characteristics other than the tip of the chip 25.

After extracting the partial image of the chip 25, the image processing unit 43 removes noise from the partial image (step 4). For the noise removal, for example, a noise removal filter, such as the median filter or the moving average filter, conventionally used in the field of image processing can be used. Step 4 may be omitted in a case where the partial image contains almost no noise.

The image processing unit 43 further extracts a cluster having the largest area included in the partial image from which noise has been removed, and determines the tip position of the cluster (step 5). Alternatively, the shape and size of the tip portion of the chip 25 assumed from, for example, the shape and area of the chip 25 and the magnification factor at the time of imaging by the camera 26 may be determined in advance, and the cluster satisfying the requirements of the shape and size may be extracted.

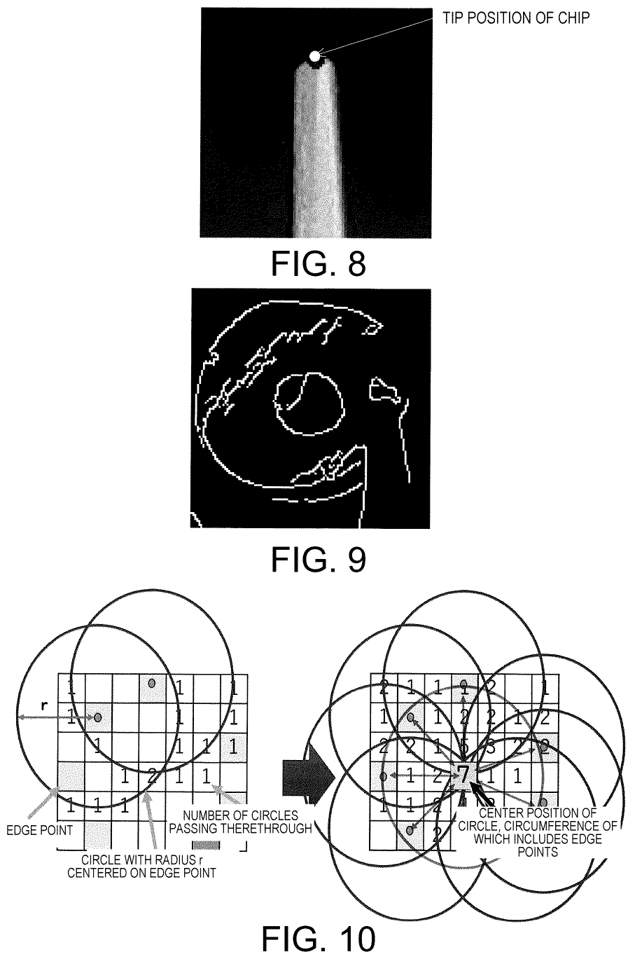

When the tip position is determined from the partial image of the chip 25, first, for example, a contour line (outline) of the cluster having the maximum area in the partial image is identified (FIG. 6). Then, the center line of the chip 25 is drawn in the middle of the outline located on both sides across the tip portion of the chip 25 and the intersection of the center line and the tip portion of the outline is obtained, and thereby the tip position of the chip 25 is determined (FIG. 7). FIG. 8 illustrates an example of a result of determining the tip position of the chip 25. When the tip position of the chip 25 is determined by the image processing unit 43, the position information acquisition unit 44 stores the information on the position in the storage unit 41.

When the information on the tip position of the chip 25 is stored in the storage unit 41, the image acquisition unit 42 moves the arm 24 to the second position (offset position) with the moving mechanism 27 (step 6). The second position is originally the position indicated by the broken line in FIG. 1, and is the sample injecting position at which the chip 25 is immediately above the opening 14. However, when the opening 14 is imaged at the sample injecting position, the chip 25 overlaps the opening 14 in the acquired image. Therefore, the arm 24 is moved to the offset position that is the position shifted by a predetermined length in a predetermined direction from the sample injecting position. The aforementioned direction and length may be appropriately determined in consideration of, for example, the size and the shape of the chip 25 so that the positions of the imaged chip 25 and the opening 14 do not overlap one another, by performing imaging in advance or the like.

Subsequently, while illuminating the vicinity of the opening 14 by turning on the LED 29, the image acquisition unit 42 acquires the image of the region including the opening 14 by the camera 26 (step 7) and stores the acquired image in the storage unit 41.

When the image including the opening 14 is acquired by the image acquisition unit 42, the image processing unit 43 first reads the image data from the storage unit 41, extracts the image of the vicinity part on the opening 14 (partial image of the opening) (step 8), and displays the extracted image on the screen of the display unit 52. The processing of extracting the partial image of the opening 14 can be performed, for example, by automatically extracting an image within a predetermined area around the center of the image obtained by the image acquisition unit 42. Since the mount error of the opening 14 that may occur when the sample heating unit 11 is attached is also about several mm at the maximum, the size of the image to be extracted (the above predetermined area) may be set in advance so as to include the opening 14 even in a case where the maximum error occurs.

A frame indicating the area of the partial image to be extracted by the above processing may be superimposed on the image read from the storage unit 41 to be displayed on the screen of the display unit 52 to allow the analyst to change the area of the partial image to be extracted as necessary. Step 8 may be omitted in a case where the opening 14 is captured sufficiently large in the image imaged by the camera 26 and there are few extra regions, or in a case where there is no region having similar shape characteristics other than the opening 14.

After extracting the partial image of the opening 14, the image processing unit 43 removes noise from the partial image (step 9). This noise removal may be performed in the same manner as the noise removal of the partial image of the chip 25. Step 9 may be omitted in a case where the partial image contains almost no noise.

Next, the image processing unit 43 extracts an edge included in the partial image of the opening 14 from which noise has been removed (step 10). Also, the edge extraction can be performed by using, for example, an edge processing filter, such as the Sobel filter, the Laplacian filter, or the Canny filter, conventionally used in the field of image processing. FIG. 9 illustrates an example of a partial image in which the edges is extracted. In this example, the edges included in the partial image from which the noise has been removed are extracted, but instead of the processing of extracting the edge, processing of binarizing the luminance value of each pixel into bright and dark by using, for example, a predetermined threshold of luminance value or a threshold obtained from the luminance distribution in the image may be performed.

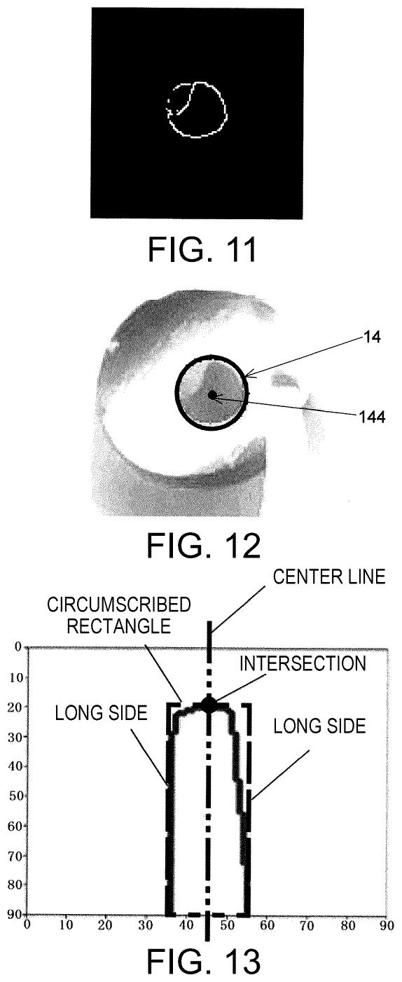

Next, the image processing unit 43 extracts a circular region corresponding to the opening 14 from the partial image after the edge extraction, and determines the center position of the circular region (step 11). The extraction of the circular region can be performed by, for example, the Hough transform. Specifically, as illustrated in FIG. 10, in the partial image after the edge extraction, a circle having a radius r centered on the position of each of the pixels (edge points) constituting the edge is drawn, and an intersection at which the most circles overlap is determined as the center position of the opening 14. FIG. 11 illustrates an example of an image including the extracted circular region corresponding to the opening 14. The size of the radius r may be determined in advance from the actual radius of the opening 14 and the magnification factor at the time of acquiring the image with the camera 26. In this method, the center position of the opening 14 can be determined with the spatial resolution at the pixel level.

The above processing using the Hough transform in the present embodiment is a method of determining the center position of the opening 14 by what is called majority decision. Therefore, even if a part of the edge of the opening 14 is missing in the partial image of the opening 14 after the edge extraction, the circle corresponding to the opening 14 can be detected. Through the repeated use of the atomic absorption spectrophotometer 1, the heating furnace constituting the sample heating unit 11 deteriorates. As a result, in the partial image of the opening 14, the contrast between the inside and the peripheral portion of the opening 14 may decrease, and a part of the edge corresponding to the opening 14 may fail to be extracted. By using the Hough transform as in the present embodiment, the center position of the opening 14 can be determined even in a case where a part of the edge corresponding to the opening 14 is not extracted.

In a case where the center position of the opening 14 is obtained with higher resolution, an intersection at which the most circles overlap is obtained by the Hough transform in the same manner as in step 11 described above, then a circle including edge points (pixels) that drew circles passing through the intersection (in other words, a circumscribed circle of all edge points that drew the circles passing through the intersection) is obtained, and the center of the circumscribed circle is determined as the center position of the opening 14. In this method, the center position of the opening 14 can be determined with the spatial resolution at the pixel level or finer. When the center position of the opening 14 is determined by the image processing unit 43, the position information acquisition unit 44 stores the information on the position in the storage unit 41.

In step 8, in a case where only the portion corresponding to the opening 14 is successfully extracted, the circumscribed circle of each of the pixels (edge points) constituting the edge may be directly obtained from the partial image after the edge extraction without performing the Hough transform, and the center of the circumscribed circle may be determined as the center position of the opening 14. FIG. 12 illustrates an example of a result of determining a center position 144 of the opening 14.

When the tip position of the chip 25 and the center position 144 of the opening 14 are determined, the position information acquisition unit 44 obtains a distance between the tip position of the chip 25 and the center position 144 of the opening 14 on the basis of their position information stored in the storage unit 41 (step 12), and stores the distance in the storage unit 41. Then, at the time of measurement of the sample to be performed after step 12, the moving mechanism 27 moves the arm 24 between the first position, the second position, and the third position on the basis of the information on the distance calculated by the position information acquisition unit 44. Thus, a mount error occurring when the analyst replaced the sample heating unit 11 or the chip 25 is eliminated.

The above embodiment is merely an example, and can be appropriately modified in accordance with the spirit of the invention.

In the above embodiment, the camera 26 and the LED 29 are attached to the arm 24, and the camera 26 and the LED 29 move together with the arm 24. However, one or both of the camera 26 and the LED 29 may be fixed, without being attached to the arm 24. In this case, the camera 26 and the LED 29 may be disposed at each of the third position and the offset position.

In the above embodiment, the tip of the chip 25 is imaged at the third position, but the region including the opening 14 and the tip of the chip 25 may be imaged at the same position (offset position of the second position). However, as in the above embodiment, imaging at the third position eliminates reflection of objects other than the chip 25, so that improvement in detection accuracy of the tip position of the chip 25 is expected. In many cases, the chip 25 made of a resin chip is used, and thus the position of the chip 25 becomes bright when a light is irradiated from the LED 29. Consequently, as the third position, a place where the background has a dark color and the contrast with respect to the chip 25 is large is selected. Alternatively, an image in which the chip 25 is dark and the background is bright may be acquired by using a light source that irradiates a light having a wavelength that does not transmit a material (resin or the like) constituting the chip 25, setting a position where the background is bright as the third position, and imaging the chip 25 at the third position.

In the above embodiment, the center position of the opening 14 and the tip position of the chip 25 are identified by the image processing, but it is not essential to the present invention to perform the image processing, and the image of the opening 14 and/or the tip of the chip 25 may be displayed on the screen of the display unit 52, and the analyst may identify the center position of the opening 14 and the tip position of the chip 25 by monitoring the image.

In a case where there are a large number of clusters of bright parts (or dark parts) smaller than the opening 14 in the image obtained by binarizing the luminance values in the partial image of the opening 14, a partial image from which noise is removed and in which the opening 14 is emphasized can be obtained by, for example, removing a cluster smaller than the opening 14 from the image by the combination with the morphology processing or the like. Furthermore, a pattern of an image corresponding to the shape of the opening 14 can be stored in advance in the storage unit 41, and a partial image can be extracted by identifying the position of the opening 14 using pattern matching.

As the method of determining the center position of the opening 14, a method different from that in the above embodiment can be adopted. For example, similarly to the above embodiment, after the contour line (outline) of the opening 14 is obtained by the Hough transform, the center of gravity of a plurality of pixels on which the outline is located may be determined as the center position of the opening 14. Alternatively, an equation of a circle that is most approximate to the outline can be obtained by the least squares method or the like, and the center position of the opening 14 can be determined from the equation.

In a case where the chip 25 is imaged at the third position, a reference image obtained by imaging only the background at the third position can be stored in the storage unit 41, and a partial image of the chip 25 can be extracted by taking a difference between an image obtained by imaging the tip of the chip 25 by the camera 26 and the reference image.

Furthermore, similarly to the above embodiment, in a case where an image in which the boundary between the chip 25 and the background of the chip 25 clearly appears can be obtained by imaging the chip 25 at the third position, the tip position of the chip 25 may be identified only by extracting the pixel located at the foremost of the tip (in a case where a plurality of pixels are arranged at the tip end, the midpoint of those pixels is extracted) without performing processing of extracting the outline, or the like. The minimum circumscribed rectangle of the cluster constituting the chip 25 in the partial image may be obtained, and the midpoint of the short side located on the tip end side may be identified as the tip position of the chip 25. Alternatively, as illustrated in FIG. 13, an intersection of a line located in the middle of the two long sides of the minimum circumscribed rectangle (center line crossing the minor axis of the rectangle) and a boundary portion on the tip end side may be specified as the tip position of the chip 25. Furthermore, in a case where the chip 25 is imaged at the third position, another camera can be disposed immediately below the chip 25 to image the chip 25, a shape (circular, rectangular, etc.) corresponding to the cross section of the chip 25 can be extracted from the image, and the center of the extracted shape can be identified as the tip position of the chip 25. The shape corresponding to the cross section can be extracted by the various methods to identify the opening 14.

In the above embodiment, when the arm 24 is at the second position, each unit is disposed such that the LED 29 is positioned on the opposite side of the camera 26 across the opening 14 in plan view, but each unit may be disposed such that the LED 29 and the camera 26 are positioned on the same side with respect to the opening 14. However, also in such a case, the LED 29 and the camera 26 are disposed so as to have different optical axes.

### Modes

It is understood by those skilled in the art that the plurality of exemplary embodiments described above are specific examples of the following modes.

### (Clause 1)

An atomic absorption spectrophotometer according to a mode of the present invention includes:
a sample collection unit to which a chip configured to collect and eject a sample is attached;
a sample heating unit with an opening in an upper face, the opening being for injecting the sample into the sample heating unit;
a moving mechanism configured to move the sample collection unit between a first position for collecting the sample into the chip and a second position for injecting the sample from the chip to the opening;
a light irradiating unit configured to irradiate a light on the opening in a predetermined lighting direction; and
an image acquisition unit configured to image the opening from a direction along an optical axis different from a central axis of the light irradiated by the light irradiating unit.

In the atomic absorption spectrophotometer of Clause 1, while the opening provided in the upper face of the sample heating unit is irradiated with a light in a predetermined lightning direction by the light irradiating unit, the opening is imaged by the image acquisition unit from a direction along an optical axis different from an optical axis of the light irradiating unit. In the atomic absorption spectrophotometer of Clause 1, the light irradiating unit and the image acquisition unit having optical axes of different directions are used to acquire the image of the opening of the sample heating unit with a contrast of bright and dark, so that the position of the opening can be easily identified.
(Clause 2)

The atomic absorption spectrophotometer according to Clause 1, in which
the image acquisition unit is disposed so as to capture a region inside the opening, the region being not irradiated with a light from the light irradiating unit, in a visual field.

### (Clause 3)

The atomic absorption spectrophotometer according to Clause 1 or 2, in which
the light irradiating unit, the image acquisition unit, and the sample heating unit are disposed such that the light irradiating unit is positioned on an opposite side of the image acquisition unit across the opening in plan view.

### (Clause 4)

The atomic absorption spectrophotometer according to Clause 1 or 2, in which
the light irradiating unit, the image acquisition unit, and the sample heating unit are disposed such that the light irradiating unit and the image acquisition unit are positioned on a same side with respect to the opening in plan view.

In the atomic absorption spectrophotometer of any one of Clauses 2 to 4, the position of the opening can be identified more accurately by imaging an image in which the upper face of the sample heating unit is bright, the opening is dark, and contrast is large. In the atomic absorption spectrophotometer of any one of Clauses 2 to 4, even in a case where the opening is imaged with the chip being attached to the sample collection unit, it is possible to easily discriminate both the opening and the chip by imaging the inside of the opening darkly and the chip brightly.

### (Clause 5)

The atomic absorption spectrophotometer according to any one of Clauses 1 to 4, in which
the moving mechanism is further configured to move the sample collection unit to a third position different from the first position and the second position, and
the image acquisition unit is configured to image a tip of the chip when the sample collection unit is at the third position.

In atomic absorption spectrophotometers, a resin chip is often used. When the resin chip is imaged, the position of the chip becomes bright. In the atomic absorption spectrophotometer of Clause 5, the chip can be imaged while being independent of the sample container at the first position and the sample heating unit at the second position. It is preferable to select, as the third position, a place where the background has a dark color and the contrast with respect to the chip is large. For example, by setting the third position where the background is dark and imaging the tip of the chip brightly at the third position, it is possible to image an image having a large contrast between the chip and the background. In a case where the chip is imaged darkly by irradiating the chip with a light having a wavelength that does not transmit the chip, or other means, the third position where the background is bright may be set. Furthermore, the silhouette of the chip may be imaged by irradiating a light from the back side of the chip (transmitted illumination).

### (Clause 6)

The atomic absorption spectrophotometer according to any one of Clauses 1 to 5, in which
the light irradiating unit and the image acquisition unit are attached to the sample collection unit.

In the atomic absorption spectrophotometer of Clause 6, since the relative positions of the light irradiating unit and the image acquisition unit are fixed, the opening can always be imaged in the same state.

### (Clause 7)

The atomic absorption spectrophotometer according to Clause 6, in which
the moving mechanism is further configured to move the sample collection unit to an offset position shifted from the second position in a horizontal direction and/or a vertical direction, and
the image acquisition unit is configured to image the opening when the sample collection unit is at the offset position.

In the atomic absorption spectrophotometer of Clause 7, by appropriately determining the offset amount, it is possible to acquire an image in which the positions of the opening of the sample heating unit and the tip of the chip are shifted.

### (Clause 8)

The atomic absorption spectrophotometer according to any one of Clauses 1 to 7, further including
an image processing unit configured to determine a center position of the opening by performing image processing on the image of the opening imaged by the image acquisition unit.

### (Clause 9)

The atomic absorption spectrophotometer according to Clause 8, in which
the opening is circular, and
the image processing unit is configured to extract a contour line of the opening by performing processing of extracting an edge included in the image of the opening or processing of binarizing a luminance value of each pixel of the image of the opening, obtain a region corresponding to the opening by the Hough transform on a basis of positions of pixels corresponding to the contour line and a value of a radius of a predetermined range and determine a center position of the opening by identifying a center of the region.

### (Clause 10)

The atomic absorption spectrophotometer according to Clause 8 or 9, in which
the image processing unit is configured to extract a region of the opening by performing processing of extracting an edge included in the image of the opening or processing of binarizing a luminance value of each pixel of the image of the opening, obtain a circumscribed circle including pixels corresponding to the region, and determine a center of the circumscribed circle as a center position of the opening.

In the atomic absorption spectrophotometer of any one of Clauses 8 to 10, since the center position of the opening is determined by the image processing unit, the center position of the opening can be easily determined without an analyst monitoring the image. As the image processing for determining the center position of the opening, for example, a method of extracting a contour line of the opening and extracting a region of the opening by the Hough transform on the basis of the positions of pixels corresponding to the contour line and a value of a radius of a predetermined range as in the atomic absorption spectrophotometer of Clause 9, or a method of extracting a region of the opening, obtaining a circumscribed circle including pixels corresponding to the region, and determining a center position of the opening as in the atomic absorption spectrophotometer of Clause 10, can be adopted. Furthermore, by combining the methods of the atomic absorption spectrophotometer of Clauses 9 and 10, extracting the region of the opening by the Hough transformation, obtaining the circumscribed circle of the region, and identifying the center of the circumscribed circle, the center position of the opening can also be determined. In the atomic absorption spectrophotometer of Clause 9, the center position of the opening can be determined with a resolution of at a pixel unit, and in the atomic absorption spectrophotometer of Clause 10, the center position of the opening can be determined with a resolution at a pixel unit or finer.

### (Clause 11)

The atomic absorption spectrophotometer according to any one of Clauses 8 to 10, in which
the image processing unit is further configured to perform processing of extracting an edge included in the image of the chip imaged by the image acquisition unit, processing of binarizing a luminance value of each pixel of the image of the chip, or processing of obtaining a difference between a background image not including the chip prepared in advance and the image of the chip, and thereby extract a contour line of the chip and identifies the tip of the chip to determine a tip position of the chip.

### (Clause 12)

The atomic absorption spectrophotometer according to Clause 11, in which
the image processing unit is configured to determine the tip position of the chip by processing of defining a center line of the chip in the middle of an outline of the chip located on both sides across a tip portion in the contour line to obtain an intersection of the center line and the tip portion, or processing of obtaining a rectangle circumscribing the contour line and identifying an intersection of a short side of the rectangle positioned on a tip end side of the chip and a center line between two long sides of the rectangle.

In the atomic absorption spectrophotometer of Clause 11 or 12, the tip position of the chip can also be identified in addition to the center position of the opening.

### (Clause 13)

The atomic absorption spectrophotometer according to any one of Clauses 8 to 12, further including
a position information acquisition unit configured to calculate a distance between a tip of the chip and the center of the opening on a basis of a processing result by the image processing unit.

In the atomic absorption spectrophotometer of Clause 13, the position information acquisition unit can calculate the distance between the tip of the chip and the center of the opening on the basis of the processing result by the image processing unit in a state where the positional deviation caused at the time of exchanging the sample heating unit or the chip has been eliminated.

### REFERENCE SIGNS LIST

1 . . . Atomic Absorption Spectrophotometer
10 . . . Measurement Unit
11 . . . Sample Heating Unit
12 . . . Light Source
13 . . . Detector
14 . . . Opening
15 . . . Light-Shielding/Heat-Insulating Member
20 . . . Autosampler
21 . . . Turntable
22 . . . Sample Container
23 . . . Shaft Member
24 . . . Arm
25 . . . Chip
26 . . . Camera
27 . . . Moving Mechanism
29 . . . LED
3 . . . Analysis Unit
4 . . . Control/Processing Unit
41 . . . Storage Unit
42 . . . Image Acquisition Unit
43 . . . Image Processing Unit
44 . . . Position Information Acquisition Unit
45 . . . Analysis Control Unit
46 . . . Measurement Data Processing Unit
51 . . . Input Unit
52 . . . Display Unit

1. An atomic absorption spectrophotometer, comprising:
a sample collection unit to which a chip configured to collect and eject a sample is attached;
a sample heating unit configured to excite the sample, provided with an opening in an upper face into which the sample is injected from the sample collecting unit;
a moving mechanism configured to move the sample collection unit between a first position for collecting the sample into the chip and a second position for injecting the sample from the chip to the opening;
a light irradiating unit configured to irradiate a light on the opening in a predetermined lighting direction; and
an image acquisition unit configured to image the opening from an optical axis direction different from the lighting direction.

2. The atomic absorption spectrophotometer according to claim 1, wherein
the image acquisition unit is disposed so as to capture a region inside the opening, the region being not irradiated with a light from the light irradiating unit, in a visual field.

3. The atomic absorption spectrophotometer according to claim 1, wherein
the light irradiating unit, the image acquisition unit, and the sample heating unit are disposed such that the light irradiating unit is positioned on an opposite side of the image acquisition unit across the opening in plan view.

4. The atomic absorption spectrophotometer according to claim 1, wherein
the light irradiating unit, the image acquisition unit, and the sample heating unit are disposed such that the light irradiating unit and the image acquisition unit are positioned on a same side with respect to the opening in plan view.

5. The atomic absorption spectrophotometer according to claim 1, wherein
the moving mechanism is further configured to move the sample collection unit to a third position different from the first position and the second position, and
the image acquisition unit is configured to image a tip of the chip when the sample collection unit is at the third position.

6. The atomic absorption spectrophotometer according to claim 1, wherein
the light irradiating unit and the image acquisition unit are attached to the sample collection unit.

7. The atomic absorption spectrophotometer according to claim 6, wherein
the moving mechanism is further configured to move the sample collection unit to an offset position shifted from the second position in a horizontal direction and/or a vertical direction, and
the image acquisition unit is configured to image the opening when the sample collection unit is at the offset position.

8. The atomic absorption spectrophotometer according to claim 1, further comprising:
an image processing unit configured to determine a center position of the opening by performing image processing on the image of the opening imaged by the image acquisition unit.

9. The atomic absorption spectrophotometer according to claim 8, wherein
the opening is circular, and
the image processing unit is configured to extract a contour line of the opening by performing processing of extracting an edge included in the image of the opening or processing of binarizing a luminance value of each pixel of the image of the opening, obtain a region corresponding to the opening by the Hough transform on a basis of positions of pixels corresponding to the contour line and a value of a radius of a predetermined range, and determine a center position of the opening by identifying a center of the region.

10. The atomic absorption spectrophotometer according to claim 8, wherein
the image processing unit is configured to extract a region of the opening by performing processing of extracting an edge included in the image of the opening or processing of binarizing a luminance value of each pixel of the image of the opening, obtain a circumscribed circle including pixels corresponding to the region, and determine a center of the circumscribed circle as a center position of the opening.

11. The atomic absorption spectrophotometer according to claim 8, wherein
the image processing unit is further configured to perform processing of extracting an edge included in the image of the chip imaged by the image acquisition unit, processing of binarizing a luminance value of each pixel of the image of the chip, or processing of obtaining a difference between a background image not including the chip prepared in advance and the image of the chip, and thereby extract a contour line of the chip and identifies the tip of the chip to determine a tip position of the chip.

12. The atomic absorption spectrophotometer according to claim 11, wherein
the image processing unit is configured to determine the tip position of the chip by processing of defining a center line of the chip in the middle of an outline of the chip located on both sides across a tip portion in the contour line to obtain an intersection of the center line and the tip portion, or processing of obtaining a rectangle circumscribing the contour line and identifying an intersection of a short side of the rectangle positioned on a tip end side of the chip and a center line between two long sides of the rectangle.

13. The atomic absorption spectrophotometer according to claim 8, further comprising:
a position information acquisition unit configured to calculate a distance between a tip of the chip and the center of the opening on a basis of a processing result by the image processing unit.
